(19) United States
(12) Patent Application Publication
(10) Pub. No.: US 2026/0134844 A1
(43) Pub. Date: May 14, 2026

(54) DISPLAYING AN OBJECT ON A PORTION OF A DISPLAY

(71) Applicant: Honeywell International Inc., Charlotte, NC (US)

(72) Inventors: Asha Nandan Malakar, Bengaluru (IN); Manoj Thankappan Nair, Bengaluru (IN); Chalapathi Subramanyam, Bengaluru (IN)

(21) Appl. No.: 18/944,496

(22) Filed: Nov. 12, 2024

(51) Int. Cl. G09G 3/34; G09G 3/36

(52) U.S. Cl. CPC G09G 3/3426; G09G 3/3648; G09G 2320/0613; G09G 2320/0686; G09G 2330/023; G09G 2340/045; G09G 2340/14; G09G 2360/16

(57) ABSTRACT

Devices, systems, and methods for displaying an object on a portion of a display are described herein. In some examples, one or more embodiments include a memory and a processor to execute instructions stored in the memory to determine, in response to a fire control panel transitioning from a normal operational mode to a battery backup mode, a scaled object to be displayed on a display panel of the fire control panel, determine, in response to the fire control panel being in the battery backup mode, a modified light emitting diode (LED) backlight setting for the scaled object, and cause the scaled object to be displayed on a sub-portion of the display panel using the modified LED backlight setting.

### TECHNICAL FIELD

The present disclosure relates to devices, systems, and methods for displaying an object on a portion of a display.

### BACKGROUND

Facilities, such as commercial facilities, office buildings, hospitals, campuses (e.g., including buildings and outdoor spaces), and the like, may have an event detection system that can be triggered during an event, such as an emergency situation (e.g., a fire) to warn occupants to evacuate. Such an event detection system may include an alarm system having a control panel and a number of event devices (e.g., sensors, sounders, pull stations, etc.) located throughout the facility (e.g., on different floors and/or in different rooms of the facility) that can perform an action when an event (e.g., a hazard event, a fault event, etc.) is occurring in the facility. In an example of an event, the number of event devices may provide a notification of the event to the occupants of the facility via alarms and/or other mechanisms.

### BRIEF DESCRIPTION OF THE DRAWINGS

FIG. 1 is an example of a system for displaying an object on a portion of a display, in accordance with one or more embodiments of the disclosure.

FIG. 2 illustrates an example of a fire control panel having a representation of a scaled object displayed on a display panel during a battery backup mode, in accordance with one or more embodiments of the disclosure.

FIG. 3 illustrates an example of a fire control panel displaying a scaled object on a display panel during a battery backup mode, in accordance with one or more embodiments of the disclosure.

FIG. 4 is an example of a controller for displaying an object on a portion of a display, in accordance with one or more embodiments of the disclosure.

### DETAILED DESCRIPTION

Devices, systems, and methods for displaying an object on a portion of a display are described herein. In some examples, one or more embodiments include a memory and a processor to execute instructions stored in the memory to determine, in response to a fire control panel transitioning from a normal operational mode to a battery backup mode, a scaled object to be displayed on a display panel of the fire control panel, determine, in response to the fire control panel being in the battery backup mode, a modified light emitting diode (LED) backlight setting for the scaled object, and cause the scaled object to be displayed on a sub-portion of the display panel using the modified LED backlight setting.

A facility can utilize an event detection system in order to warn occupants of the facility of an emergency event, such as a fire. An event detection system can be a system of devices that operate to collect information about a facility and provide the collected information for analysis. Such an event detection system can also take actions based on the collected information, such as providing an audible and/or visible warning in an emergency event. For example, the event detection system can utilize event devices to warn occupants of an emergency event occurring in a space, such as a fire.

As used herein, the term “event device” refers to a device that can receive an input relating to an event and/or generate an output relating to an event. Such event devices can be a part of the event detection system of a space in a facility/in the facility at large and can include devices such as fire devices including fire sensors, smoke detectors, heat detectors, carbon monoxide (CO) detectors, or combinations of these; fire control panels; air quality sensors; interfaces; manual call points (MCPs); pull stations; input/output modules; aspirating units; fire doors; and/or audio/visual devices (e.g., speakers, sounders, flashers, buzzers, microphones, cameras, video displays, video screens, etc.), relay output modules, among other types of event devices. Such event devices may also include self-test capabilities.

In an event detection system, a control panel, such as a fire control panel, can utilize a display panel in order to display information to a user. For example, the display panel can display information relating to event devices in the system such as their status, whether any events are occurring, etc. If an event occurs, the display panel can display information relating to the event, such as the type of event, the event device that detected the event, the location of the event device, etc.

During normal operation of the control panel, the control panel can be powered by a power mains. For instance, an alternating current (AC) mains can provide power to the control panel during normal operation.

However, in an instance in which the AC mains to the control panel is lost, the control panel can operate in a battery backup mode. While in the battery backup mode, a battery can provide power to the control panel to enable the control panel to continue to operate. For example, the control panel can communicate (e.g., transmit and/or receive information) with event devices in the facility and/or with remote computing devices (e.g., cloud computing devices, remote computing devices, mobile devices, etc.) while being powered by the battery in the battery backup mode.

While in the battery backup mode, the control panel can operate while the battery powering the control panel has power. However, the battery life of the battery can be affected by various factors, including control panel settings, the environment in which the control panel is located, and usage patterns. The battery life can also be negatively impacted by the display panel. For example, the content (e.g., the objects) displayed by the display panel, the color of the objects displayed, the brightness of the display panel, and/or the backlight efficiency of the display panel, among other examples, can negatively affect the battery life of the battery.

Therefore, consideration of how information is displayed by the display panel can increase the battery life of the battery. However, regulatory guidelines for event detection systems can dictate certain information that has to be displayed on the display panel of the control panel while in a battery backup mode.

Displaying an object on a portion of a display, according to the disclosure, can allow for objects to be displayed on a display panel of a control panel during a battery backup operational mode while conserving battery power of the battery of the control panel. For example, a scaled object can be displayed on the display panel of the control panel using modified backlight settings. The scaled object can be displayed on a portion of the display panel with the remaining portion of the display panel being turned off, utilizing less panel and backlight power and allowing for a longer battery life of the backup battery, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

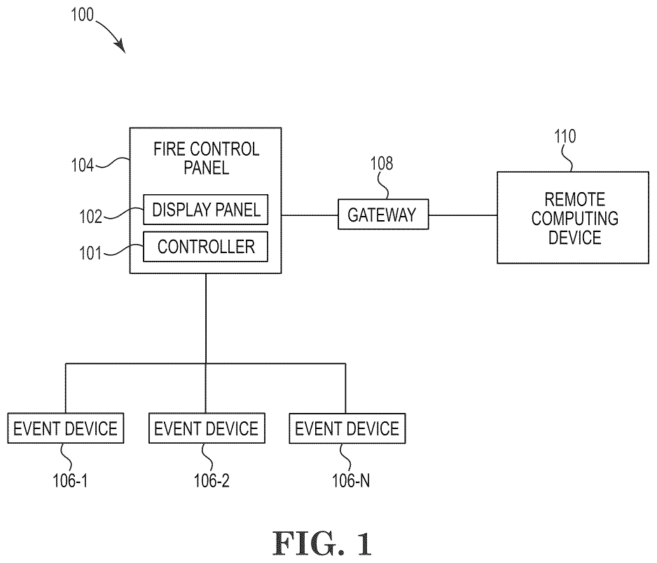

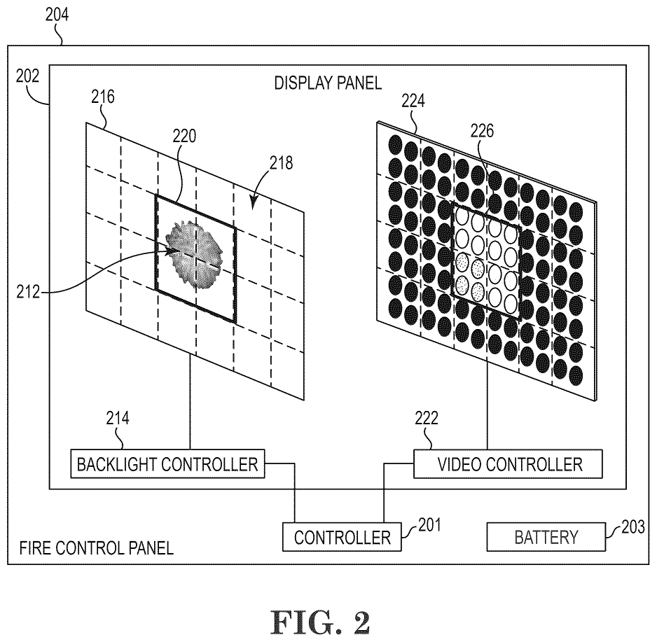

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example of a system 100 for displaying an object on a portion of a display, in accordance with one or more embodiments of the disclosure. The system 100 can include fire control panel 104, event devices 106-1, 106-2, 106-N (referred to collectively herein as event devices 106), gateway 108, and remote computing device 110.

As mentioned above, the system 100 can be included in a facility, a space in a facility, etc. The system 100 can include a device/series of devices in order to detect events and/or process and/or analyze the detected events to determine whether to generate an alarm for occupants of the facility.

For example, the system 100 can include event devices 106. The event devices 106 can be devices to detect an event and transmit the detected event for processing and/or analysis. As mentioned above, the event devices 106 can include, for example, cameras, motion sensors, fire devices including fire sensors, smoke detectors, heat detectors, carbon monoxide (CO) detectors, or combinations of these; fire control panels; air quality sensors; interfaces; manual call points (MCPs); pull stations; input/output modules; aspirating units; fire doors; and/or audio/visual devices (e.g., speakers, sounders, flashers, buzzers, microphones, cameras, video displays, video screens, etc.), relay output modules, among other types of event devices. Additionally, event devices 106 may also include self-test capabilities.

The system 100 can further include the fire control panel 104. The fire control panel 104 can be utilized to control the various event devices 106 included in the system 100.

The fire control panel 104 can be connected to the event devices 106, transmit a plurality of commands to the event devices 106, and/or provide power to the event devices 106. The fire control panel 104 can apply a voltage to an event device loop in order to power event devices 106 on the event device loop. Such power can allow the event devices 106 to perform actions, such as communication between event devices 106 and the fire control panel 104, self-test procedures, and/or provide an audible and/or visible warning in an event, among other actions.

The fire control panel 104 may be further connected to a remote computing device 110 via a gateway 108. The gateway 108 can be a device (e.g., a building system gateway) that provides a communication link between the fire control panel 104 and other devices, such as the remote computing device 110. For example, the gateway 108 may enable transmission of data (e.g., system device data, activation signals, etc.) from the fire control panel 104 to the remote server 110 and vice versa.

The fire control panel 104 can further include a controller 101 and a display panel 102. As used herein, the term “display panel” refers to an area of a display device that displays information. For example, a fire control panel 104 can include a display device having a display panel 102 that can display information such as text, videos, images, or combinations thereof as a result of an electrical signal provided to the display panel 102 from the fire control panel 104.

The display panel 102 can provide (e.g., display and/or present) information to the user of the fire control panel 104, and/or receive information from (e.g., input by) the user of the fire control panel 104. For instance, in some embodiments, display panel 102 can include a graphical user interface (GUI) that can provide information to and/or receive information from the user of the fire control panel 104. The display panel 102 can be, for instance, a touchscreen (e.g., the GUI can include touch-screen capabilities). Alternatively, the display panel 102 can include a television, computer monitor, mobile device screen, other type of display device, or any combination thereof, connected to the fire control panel 104 and configured to receive a video signal output from the fire control panel 104.

As mentioned above, during a battery backup mode of the fire control panel 104, the display panel 102 can display a scaled object on the display panel 102. The scaled object displayed on the display panel 102 can help preserve the battery life of a battery of the fire control panel 104 during the battery backup mode as compared to a default object being displayed on the display panel 102 during a normal operational mode, as is further described herein.

FIG. 2 illustrates an example of a fire control panel 204 having a representation of a scaled object 212 displayed on a display panel 202 during a battery backup mode, in accordance with one or more embodiments of the disclosure. The fire control panel 204 can include a battery 203. The display panel 202 can include a backlight controller 214, a backlight LED matrix 216, a video controller 222, and a plurality of pixels 224.

As illustrated in FIG. 2, the fire control panel 204 can include a controller 201 and a display panel 202. In some examples, the display panel 202 can be an LCD panel. For example, the display panel 202 can utilize liquid crystals to create images on a screen. The images can be, for example, objects associated with operation of the fire control panel 204.

As used herein, the term “object” refers to information associated with operation of a fire control panel. For example, an object can include textual and/or graphical representations of data associated with operation of the fire control panel 204. Such representations of data may include textual data describing operation of the event detection system (e.g., operational information about a particular event device in the event detection system such as whether the event device has detected an event, whether the event device has a fault, whether the event device is active/disabled, operational information about the fire control panel 204, etc.), as well as graphical representations of data describing operation of the event detection system (e.g., operational information about the fire control panel such as whether an event device has detected an event, whether the event device has a fault, whether the event device is active/disabled, etc.).

As mentioned above, the display panel 202 can be an LCD panel comprising a backlight LED matrix 216 and a plurality of pixels 224. As used herein, the term “backlight LED matrix” refers to an array of LED lights used for backlighting to display information on the display panel 202. The backlight LED matrix 216 can include a plurality of backlights 218 arranged in an array. The plurality of backlights 218 can illuminate a plurality of pixels 224 of the display panel 202, as is further described herein. Additionally, the display panel 202 can include a backlight controller 214. The backlight controller 214 can control the plurality of backlights 218 so as to cause certain ones of the plurality of backlights 218 to illuminate certain pixels of the plurality of pixels 224, as is further described herein.

The display panel 202 can further include a plurality of pixels 224. The plurality of pixels 224 can be a grid of pixels that, when illuminated by a backlight LED matrix 216, can display information on the display panel 202. Additionally, the display panel 202 can include a video controller 222. The video controller 222 can control the plurality of pixels 224, as is further described herein.

As mentioned above, the display panel 202 can display objects related to the operation of the fire control panel 204. During a normal operational mode of the fire control panel 204, during which an AC mains (e.g., not illustrated in FIG. 2) is providing power to the fire control panel 204, can display a default object on the display panel 204. The default object can include text and/or graphical representations associated with operation of the fire control panel 204 and/or operation of the event detection system. In some examples, the default object can utilize the entirety of the display panel 202 to display information, as power consumption considerations are not important when the fire control panel 204 is powered by the AC mains.

In an event in which the AC mains is unable to provide power to the fire control panel 204, the fire control panel 204 can switch from the normal operational mode to a battery backup mode. During the battery backup mode, the fire control panel 204 can continue to control event devices in the event detection system, transmit commands to the event devices, and/or provide information to a user of the fire control panel 204. However, the fire control panel 204 can be powered by the battery 203 during the battery backup mode.

Accordingly, power consumption of the fire control panel 204 is a concern while the fire control panel 204 operates in the battery backup mode. Accordingly, the display panel 202 can display a scaled object instead of a default object. The scaled object can include text associated with the fire control system. The scaled object can be displayed on a portion of the display panel 202 instead of the entirety of the display panel 202 and can consume less power as compared with the display of the default object. Accordingly, the scaled object can be displayed on the display panel 202 during the battery backup mode, as is further described herein.

The controller 201 can determine, in response to the fire control panel 204 transitioning from the normal operational mode to the battery backup mode, a scaled object to be displayed on the display panel 202. The controller 201 can determine the scaled object to be displayed using a lookup table.

As used herein, the term “lookup table” refers to a data structure that maps input values to output values. During the normal operational mode, the default object can include a graphic illustrating a depiction of an event device (e.g., the shape, location in the facility, status information, etc.) that is displayed on the display panel 202. The controller 201 can use the default object displayed on the display panel 202 when the fire control panel 204 is in the normal operational mode as an input value that is mapped to an output value (e.g., a scaled object). For example, in an object lookup table, the scaled object can be associated with the default object such that using the default object as an input value, the controller 201 can determine the scaled object as the output value via the object lookup table.

As mentioned above, the scaled object can be smaller than the default object when displayed on the display panel 202. For instance, as mentioned above, the default object can include a graphic illustrating a depiction of the event device, whereas the scaled object can be textual information describing the event device, where the textual information is displayed on a smaller area of the display panel 202 than the default object would be when displayed on the display panel 202. Utilizing the smaller area of the display panel 202 for the scaled object can reduce power consumption as compared with using a larger area of the display panel 202 for the default object, increasing the battery life of the battery 203 during the battery backup mode of the fire control panel 204.

The scaled object can include predetermined image settings different from that of the default object. For example, the default object may include color settings, contrast settings, saturation ratios, etc. that are utilized to provide a quality image of the depiction of the event device, whereas the scaled object can include predetermined color settings and contrast settings that provide a quality image of the scaled object.

As mentioned above, an object is comprised of data, such as red, green, and blue (RGB) pixel data that can cause a display panel 202 to display information. However, such data has to be first converted to a video signal. Accordingly, although not illustrated in FIG. 2, the display panel 202 can include a frame buffer. As used herein, the term “frame buffer” refers to a portion of memory that includes a bitmap that drives a video display. The memory can be included in the display panel 202. The controller 201 can cause the scaled object to be converted to a video signal via the frame buffer.

Additionally, in response to the fire control panel 204 being in the battery backup mode, the controller 201 can determine modified LED backlight settings for the backlight LED matrix 216 for the scaled object using a backlight settings lookup table. During the normal operational mode, the default object can include reference backlight settings (e.g., reference luminance settings) for the backlight LED matrix 216. Similar to the image settings, in the backlight settings lookup table, the reference backlight setting of the default object in the backlight settings lookup table can be associated with modified LED backlight settings of the scaled object such that the controller 201 can use the default object (e.g., having reference LED backlight settings) as an input value that is mapped to an output value (e.g., the scaled object having modified backlight settings) in the backlight settings lookup table.

The modified LED backlight settings can be dimmer than the reference backlight settings. Utilizing the dimmer modified LED backlight settings for the scaled object can reduce power consumption as compared with using brighter reference backlight settings for the default object, increasing the battery life of the battery 203 during the battery backup mode of the fire control panel 204.

Accordingly, as described above, the controller 201 has determined a scaled object and associated backlight settings for displaying the scaled object on the display panel 202. The controller 201 can cause the scaled object to be displayed using the associated backlight settings by causing a subset of pixels to be enabled and illuminating a sub-portion of the plurality of backlights, as is further described herein.

As mentioned above, the display panel 202 can include a plurality of backlights 218 making up the backlight LED matrix 216 and a plurality of pixels 224. The controller 201 can cause the scaled object to be displayed on a sub-portion of the display panel 202 (e.g., a portion of the display panel 202 that is smaller than the entirety of the display panel 202) as is further described herein.

The controller 201 can cause a subset 226 of the plurality of pixels 224 to be enabled according to a video signal from the frame buffer. As mentioned above, the frame buffer can convert the scaled object to a video signal. The controller 201 can cause the video controller 222 to enable a subset 226 of pixels of the plurality of pixels 224 to cause the scaled object to be displayed on a portion of the display panel 202. Accordingly, the scaled object can be displayed on a sub-portion of the display panel 202.

Additionally, the controller 201 can illuminate a sub-portion 220 of the plurality of backlights 218 of the backlight LED matrix 216 according to the modified LED backlight settings. For example, the controller 201 can cause the backlight controller 214 to illuminate the sub-portion 220 of the plurality of backlights 218 in the backlight LED matrix 216 according to the modified LED backlight settings.

The subset 226 of the plurality of pixels 224 can have a same corresponding location on the display panel 202 as the sub-portion 220 of the plurality of backlights 218 of the backlight LED matrix 216. As the subset 226 of the plurality of pixels 224 match up with the sub-portion 220 of the plurality of backlights 218, the scaled object can be displayed on the display panel 202.

A remaining portion of the plurality of pixels 224 separate from the subset 226 of the plurality of pixels 224 are not enabled by the video controller 222. Additionally, a remaining portion of the plurality of backlights 218 separate from the sub-portion 220 of the plurality of backlights 218 are not illuminated by the backlight controller 214.

Accordingly, displaying an object on a portion of a display, according to the disclosure, can allow for a scaled object to be displayed on a display panel of a control panel during a battery backup operational mode. The scaled object can be smaller than a default object and as such is displayed on a smaller portion of the display panel as compared with the default object. Additionally, the scaled object can include backlight settings that are dimmer than reference backlight settings for the default object. Accordingly, displaying the scaled object on the smaller portion of the display panel using dimmer backlight settings as compared to a default object, where the remaining portion of the display panel is turned off, can allow for less power consumption and longer battery life of a backup battery while still displaying necessary information according to regulatory guidelines without losing image quality, as compared with previous approaches. The longer battery life can allow for lower battery maintenance costs and reduced costs for charging modules, as compared with previous approaches.

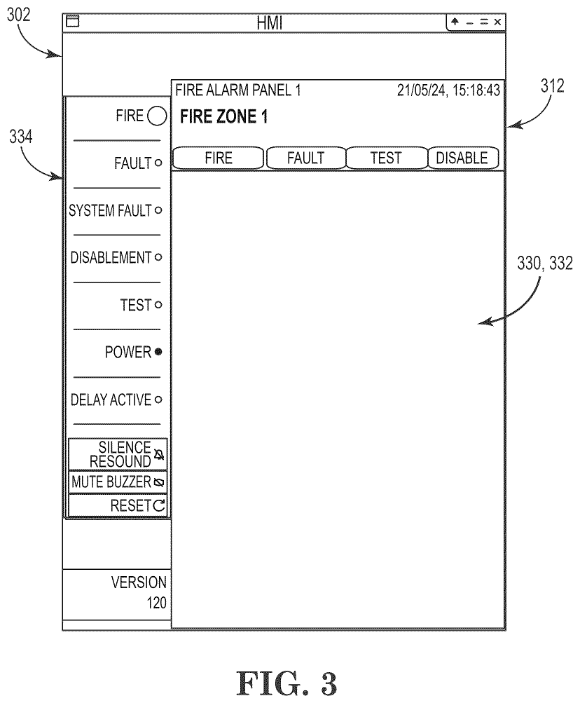

FIG. 3 illustrates an example of a fire control panel displaying a scaled object 312 on a display panel 302 during a battery backup mode, in accordance with one or more embodiments of the disclosure. The display panel 302 can include the scaled object 312, as well as hard LEDs 334.

As illustrated in FIG. 3, the fire control panel including the display panel 302 can be in a battery backup mode. The scaled object 312 can include a representation of textual data describing operation of the event detection system. For example, the scaled object 312 can include textual data indicating Fire Zone 1 is in a Fire condition. The scaled object 312 can be displayed on a sub-portion of the display panel 302 using modified LED backlight settings based on a video controller enabling a subset of a plurality of pixels of the display panel 302 and a backlight controller enabling a sub-portion of a plurality of backlights of a backlight LED matrix of the display panel 302.

As illustrated in FIG. 3, a remaining portion 330 of the plurality of backlights, separate from the sub-portion of the plurality of backlights that are illuminated, are not illuminated by the backlight controller. Additionally, a remaining portion 332 of the plurality of pixels, separate from the subset of the plurality of pixels that are enabled, are not enabled by the video controller.

Additionally illustrated in FIG. 3 are hard LEDs 334 of the fire control panel. As used herein, the term “hard LED” refers to a light that indicates a status of a condition. For example, the hard LEDs 334 can be lights that indicate, when they are turned on, whether a particular condition is met. These conditions can include whether a fire event is occurring, whether a test is occurring, whether a fault has occurred, etc. During the battery backup mode, two of the hard LEDs 334 can be illuminated indicating power is being provided to the fire control panel (e.g., via a battery) and that a fire has been detected. The hard LEDs 334 can operate during a normal operational condition and during a battery backup condition of the fire control panel, and are not disabled during the battery backup condition as the hard LEDs 334 consume very little power from the battery during the battery backup condition. As such, the hard LEDs 334 can provide additional information to a user of the fire control panel during a battery backup condition.

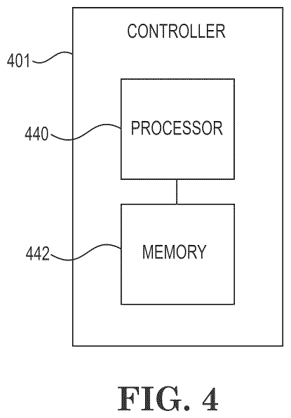

FIG. 4 is an example of a controller 401 for displaying an object on a portion of a display, in accordance with one or more embodiments of the disclosure. As illustrated in FIG. 4, the controller 401 can include a memory 442 and a processor 440 for displaying an object on a portion of a display, in accordance with the present disclosure.

The memory 442 can be any type of storage medium that can be accessed by the processor 440 to perform various examples of the present disclosure. For example, the memory 442 can be a non-transitory computer readable medium having computer readable instructions (e.g., executable instructions/computer program instructions) stored thereon that are executable by the processor 440 for displaying an object on a portion of a display in accordance with the present disclosure.

The memory 442 can be volatile or nonvolatile memory. The memory 442 can also be removable (e.g., portable) memory, or non-removable (e.g., internal) memory. For example, the memory 442 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 442 is illustrated as being located within the controller 401, embodiments of the present disclosure are not so limited. For example, memory 442 can also be located internal to another computing resource (e.g., enabling computer readable instructions to be downloaded over the Internet or another wired or wireless connection).

The processor 440 may be a central processing unit (CPU), a semiconductor-based microprocessor, and/or other hardware devices suitable for retrieval and execution of machine-readable instructions stored in the memory 442.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A controller, comprising:
a memory; and
a processor configured to execute executable instructions stored in the memory to:
determine, in response to a fire control panel transitioning from a normal operational mode to a battery backup mode, a scaled object to be displayed on a display panel of the fire control panel;
determine, in response to the fire control panel being in the battery backup mode, a modified light emitting diode (LED) backlight setting for the scaled object; and
cause the scaled object to be displayed on a sub-portion of the display panel using the modified LED backlight setting.

2. The controller of claim 1, wherein the processor is configured to determine the scaled object via an object lookup table using a default object displayed on the display panel when the fire control panel is in the normal operational mode.

3. The controller of claim 2, wherein the scaled object is associated with the default object in the object lookup table.

4. The controller of claim 2, wherein the scaled object is smaller than the default object when displayed on the display panel.

5. The controller of claim 2, wherein the scaled object includes predetermined image settings different from that of the default object.

6. The controller of claim 1, wherein the processor is configured to determine the modified LED backlight setting via a backlight settings lookup table using a reference backlight setting associated with a default object displayed on the display panel when the fire control panel is in the normal operational mode.

7. The controller of claim 6, wherein the modified LED backlight setting is associated with the reference backlight setting in the backlight settings lookup table.

8. The controller of claim 6, wherein the modified LED backlight setting is dimmer than the reference backlight setting.

9. The controller of claim 1, wherein the processor is configured to cause the scaled object to be displayed by causing a backlight controller to illuminate a sub-portion of a plurality of backlights included in a backlight LED matrix of the display panel according to the modified LED backlight setting.

10. The controller of claim 1, wherein the processor is configured to cause the scaled object to be displayed by causing a video controller to enable a subset of a plurality of pixels of the display panel.

11. A method, comprising:
determining, by a controller in response to a fire control panel transitioning from a normal operational mode to a battery backup mode, a scaled object to be displayed on an LCD panel of the fire control panel using an object lookup table, wherein the fire control panel displays a default object on the LCD panel in the normal operational mode;
determining, by the controller in response to the fire control panel being in the battery backup mode, modified LED backlight setting for a backlight LED matrix for the scaled object using a backlight settings lookup table; and
causing, by the controller, the scaled object to be displayed on a sub-portion of the LCD panel using the modified LED backlight setting.

12. The method of claim 11, wherein the method includes converting, by a frame buffer of the LCD panel, the scaled object to a video signal.

13. The method of claim 12, wherein the method includes causing, by a video controller, a subset of pixels of a plurality of pixels to be enabled according to the video signal from the frame buffer to cause the scaled object to be displayed.

14. The method of claim 13, wherein the method includes displaying the scaled object on a sub-portion of the LCD panel.

15. The method of claim 11, wherein the method includes illuminating, by a backlight controller, a sub-portion of a plurality of backlights of the backlight LED matrix of the display panel according to the modified LED backlight setting.

16. A fire control panel, comprising:
a liquid crystal display (LCD) panel comprising:
a plurality of pixels;
a video controller to control the plurality of pixels;
a backlight light emitting diode (LED) matrix comprising a plurality of backlights; and
a backlight controller to control the plurality of backlights; and
a controller configured to:
determine, in response to the fire control panel transitioning from a normal operational mode to a battery backup mode, a scaled object to be displayed on the LCD panel using an object lookup table, wherein the fire control panel displays a default object on the LCD panel in the normal operational mode;
determine, in response to the fire control panel being in the battery backup mode, modified LED backlight setting for the backlight LED matrix for the scaled object using a backlight settings lookup table; and
cause the scaled object to be displayed on a sub-portion of the LCD panel by:
causing a subset of the plurality of pixels to be enabled according to a video signal from a frame buffer; and
illuminating a sub-portion of the plurality of backlights of the backlight LED matrix according to the modified LED backlight setting.

17. The fire control panel of claim 16, wherein the subset of the plurality of pixels has a same corresponding location on the LCD panel as the sub-portion of the plurality of backlights of the backlight LED matrix.

18. The fire control panel of claim 16, wherein:
a remaining portion of the plurality of pixels separate from the subset of the plurality of pixels are not enabled by the video controller; and
a remaining portion of the plurality of backlights separate from the sub-portion of the plurality of backlights are not illuminated by the backlight controller.

19. The fire control panel of claim 16, wherein the scaled object is comprised of text associated with a fire control system.

20. The fire control panel of claim 16, wherein the default object is comprised of at least one of text and graphical representations associated with a fire control system.
